(19) United States
(12) Patent Application Publication
(10) Pub. No.: US 2020/0157868 A1
(43) Pub. Date: May 21, 2020

(54) SLIDING AND BRAKING DEVICE FOR SLIDING DOORS AND SHUTTERS

(71) Applicants: Nicola BALLOTTA, Marano Sul Panaro (IT); TERNO SCORREVOLI S.P.A. UNIPERSONALE, Varedo (IT)

(72) Inventor: Giovanni TERNO, Varedo (IT)

(21) Appl. No.: 16/340,560

(22) PCT Filed: Jan. 17, 2018
(86) PCT No.: PCT/EP2018/000024

§ 371 Date: Apr. 9, 2019

(30) Foreign Application Priority Data
Jan. 27, 2017 (IT) 102017000008876

(51) Int. Cl. E05F 5/00; E05F 1/16; E05D 15/06

(52) U.S. Cl. CPC E05F 5/003; E05F 1/16; E05Y 2900/132; E05Y 2201/41; E05D 15/063; E05Y 2800/24

(57) ABSTRACT

A sliding and braking device (10) of sliding doors closing off and opening two adjacent rooms comprises a profile (12) made of metal or other suitable material having a substantially “C” shaped cross-section with a lower horizontal branch or base (22), attached with screws or equivalent means to the inner face of the door (14) to be moved and fitted with an inverted “U” seat constituting the sliding guide (19) for one or more wheels (20) of at least one support (40) attached to a wall (42), above the through opening between said rooms. The device further comprises two damper stops (24), each consisting of a piston (26), a coil spring (28) overlapping one another and a pivoting slider (38). The two damper stops (24) are opposite and fixed along the base (22) of the profile (12) misaligned with each other; the pivoting slider (38) which such stops are fitted with, are provided with and abutted by an appendage (56) and (58) projecting from the support (40) and defining an actuator.

The present invention relates to a sliding and braking device for sliding doors and shutters.

More in particular, the present invention relates to a device as defined above suitable to allow an effective improvement of the braking effect of traditional damper stops which slow down the movement of the door or shutter both in the opening and closing phases.

It is known that sliding doors, used especially to close off when needed, the passage between two adjacent rooms, are connected with specific devices that ensure adequate sliding of the same in opening and closing. Such devices comprise an upper guide fixed to the wall, for the sliding of one or more carriages provided with an appendage protruding downward from said guide and connected to the upper end of the door; a complementary lower guide is integrated flush with the floor in which wheels or rollers connected to the bottom edge of the door slide. A solution of this kind is described in the patent application EP 2 913 468 A1 by the same applicant.

According to another known and widespread solution by the same applicant, typically used for realising sliding doors projecting from the wall, an upper guide consisting of a shaped section is fixed to the door to be moved at or near its top edge; in the aforementioned section opposite damper stops are housed aligned longitudinally with each other, consisting of a gas piston cooperating with a coil spring. During the opening and closing movement of the door, said damper stops are alternately in contact with an actuator, consisting of an appendage projecting from the central part of a carriage fixed to the wall provided with wheels to facilitate the sliding of the shaped section. Said known damper stops may however perform a limited and very short stroke, approximately 30 mm, since the overall dimensions defined by the exposure of the stem of both opposite pistons cannot exceed the overall longitudinal extension of the body on which said pistons are arranged in alignment. This causes a significant limitation of the progressive braking effect on the door, both during opening and closing.

WO 2012/073215 discloses the solution of making a sliding door provided with guide and support means having a very limited dimension with respect to the extension of the opening to be shielded; said door comprises rotating members with at least one idler wheel, with longitudinal guide members comprising a section with a rail extending in a direction parallel to the direction of translation of the shutter. DE 10 2008 061728 concerns a sliding door with a shutter suspended from least one carriage and guided so as to slide along a rail positioned on the wall or ceiling.

DE 20 2012 002884 refers to a damper to mitigate the relative movement of the moving parts of a device and comprises two clamping members.

The purpose of the present invention is to overcome the drawback above complained.

More specifically, the purpose of the present invention is to provide a sliding and braking device for sliding doors and shutters in which the damper stops can perform a complete stroke as regards the exposure of the stem of the opposite pistons, all to the advantage of the effective and progressive braking of the door, both during opening and closing.

A further aim of the invention is to provide a sliding and braking device for sliding doors and shutters as defined above in which both the stems of opposite pistons can be exposed entirely, avoiding in any case exceeding the overall longitudinal extension of the body on which said pistons are arranged.

A further purpose of the invention is to make available to users a sliding and braking device for sliding doors and shutters suitable to ensure a high level of resistance and reliability over time, in addition such as to be easily and economically made.

These and other purposes are achieved by the sliding and braking device for sliding doors of the present invention according to the main claim.

The construction and functional characteristics of the sliding and braking device for sliding doors and shutters of the present invention will be more clearly comprehensible from the detailed description below in which reference is made to the appended drawings which show a preferred and non-limiting embodiment and wherein:

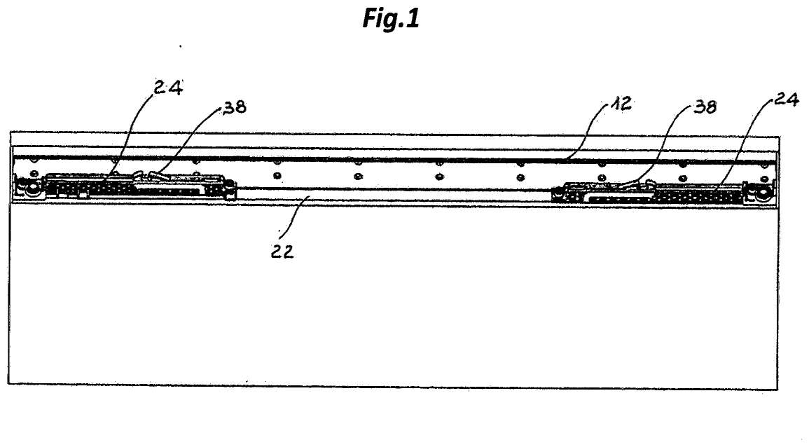

FIG. 1 represents schematically an axonometric view of the upper guide, consisting of a shaped profile fixed to the door to be moved on which opposite supports are arranged comprising respective damper stops according to the invention;

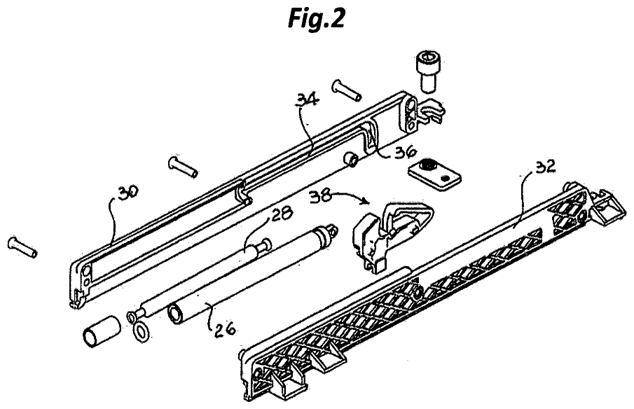

FIG. 2 represents schematically an exploded view of one of the supports comprising the damper stop;

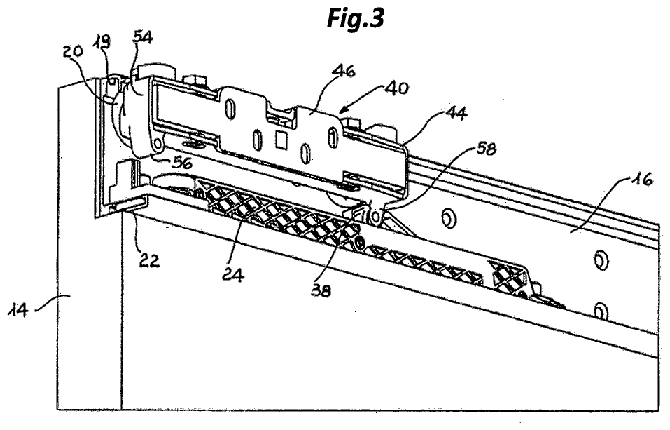

FIG. 3 schematically shows a partial axonometric view of the inner face of one end of the door to be moved, highlighting the shaped profile, one of the supports comprising the damper stop and one of the carriages along which said section slides;

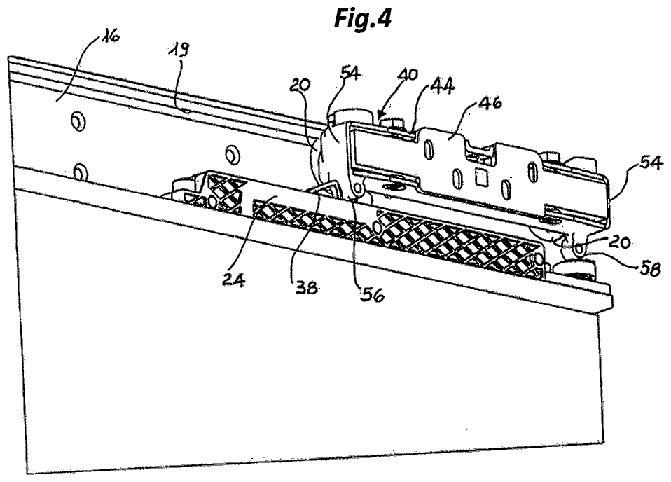

FIG. 4 represents schematically a partial axonometric view of the inner face of the opposite end of the door to be moved, highlighting the same shaped profile, one of the supports with the damper stop and one of the carriages along which said profile slides;

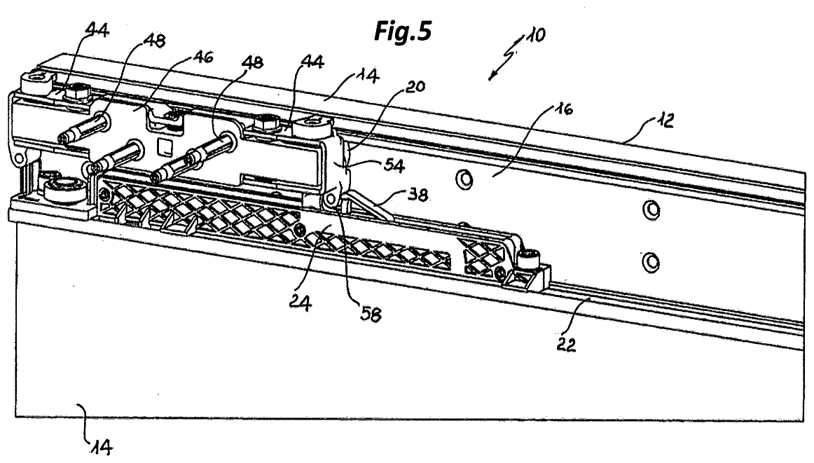

FIG. 5 represents schematically a partial axonometric view of the inner face of one end of the door to be moved according to a different angle from the one in FIG. 3;

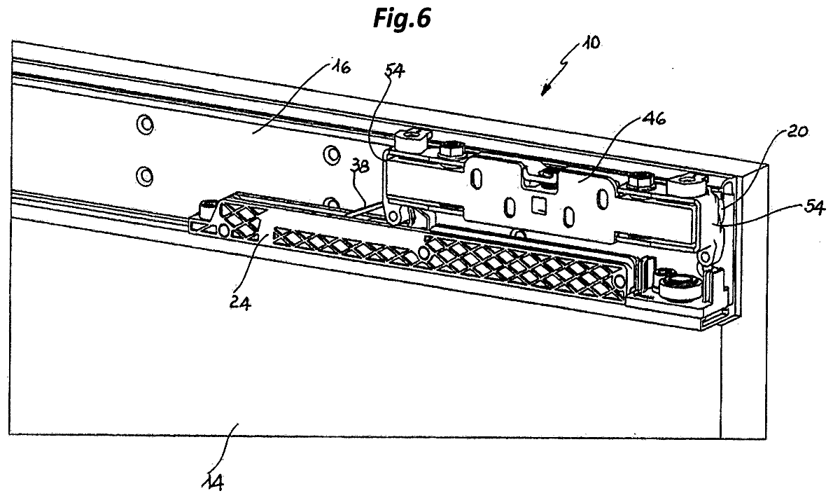

FIG. 6 represents schematically a partial axonometric view of the inner face of the opposite end of the door to be moved according to a different angle from the one in FIG. 4;

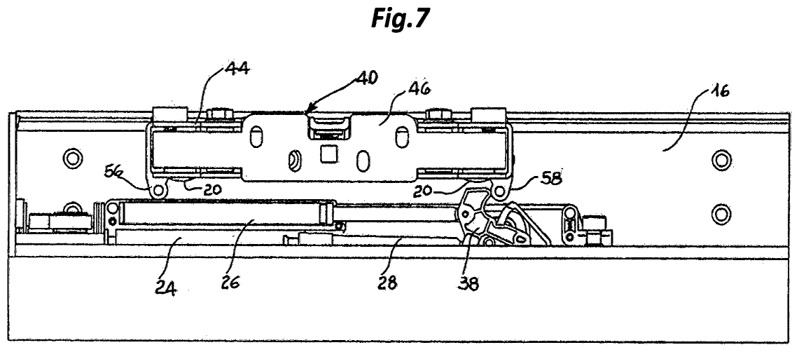

FIG. 7 represents schematically a frontal schematic view of the device of the invention, to highlight the damper stop placed at one end of the shaped section fixed to the door to be moved;

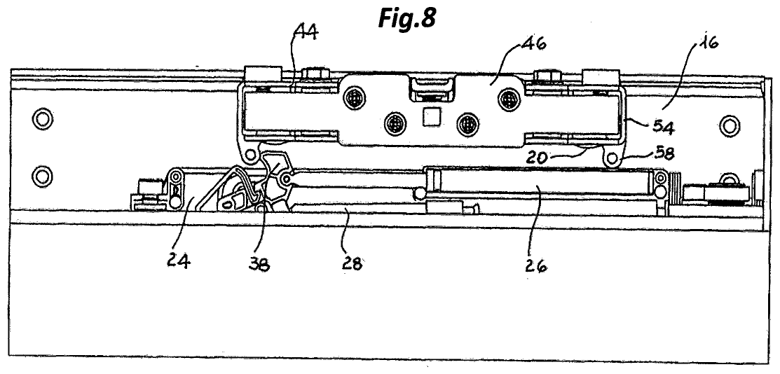

FIG. 8 represents schematically a frontal schematic view of the device of the invention, to highlight the damper stop placed at the opposite end of the shaped section fixed to the door to be moved;

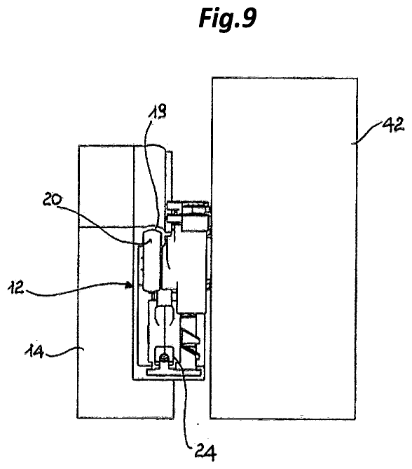

FIG. 9 represents schematically a front view of the device of the invention placed between the sliding door and the wall comprising the room to be screened.

With initial reference to FIGS. 1 and 2, the device for the sliding and braking of sliding doors and shutters of the invention, globally denoted by reference numeral 10 in FIGS. 5 and 6, comprises a profile 12 in metal or other suitable material having a substantially “C” shaped cross-section, in this case, it is fixed with screws or equivalent means to the inner face of the door to be moved, indicated by reference numeral 14, flush with the top edge of said door. The vertical branch 16 of the profile 12 thus adheres to the inner face of the door 14. The upper branch 18 of said section extends cantilevered horizontally in the direction opposite to the door 14 and is then bent downwards for a limited height, forming an inverted “U” seat constituting the sliding guide or rail 19 of one or more wheels 20 described further below. The opposite lower branch or base 22 of the profile 12 extends cantilevered horizontally in the opposite direction to the door 14 to a greater height than the upper branch 18 and defines a longitudinally extending flat surface on which opposite damper stops 24, in themselves known, are fixed. As shown in FIG. 2, each of said damper stops comprises an air or gas piston 26 and a coil spring 28, housed and superposed in a frame formed by a snap or pressure coupling of two plate-like shaped elements 30, 32; said latter comprise a groove 34, having a downward bend 36 at one end, along which the known pivoting slider 38 is guided in sliding by a protruding pawl 50 which said slider is fitted with. The slider 38 is intended to be intercepted and driven by an actuator described below, which leads said slider to compress or load the coil spring 26 and at the same time abut the exposed stem of the piston 24. According to the invention, the opposite damper stops 24 fixed along the lower branch or base 22 of the profile 12, intended to slow down the excursion of the door 14 in opening or closing are misaligned with each other as may be seen in the first place in FIG. 1; from the observation of such a figure, it is in fact clear that one of the damper stops 24, particularly the one shown on the left side of the drawing, is positioned on said base 22 near the vertical branch 16 of the profile 12, while the opposite damper stop 24, shown on the right side of the same drawing, is positioned on said base 22 along the outermost part and distant from the vertical branch 16. The respective pivoting sliders 38 integrated in the opposite damper stops 24 are therefore also misaligned; said pivoting sliders 38 may be constrained with any means to the lower branch or base 22 of the profile 12.

Said damper stops 24 fixed to the base 22 of the profile 12 and misaligned with each other are destined to cooperate with a support 40 suitably fixed to the wall behind the door 14 denoted by 42 in FIG. 9, and above the opening destined to be screened or made available, in whole or in part, by effect of the sliding open or closed of said door. The wall support 40 comprises with reference by way of example to FIGS. 3, 4, 5 a substantially rectangular perimetral reinforcement 44, which delimits and bears integrally therewith a shaped plate 46 destined to be fastened with anchor plugs 48 to said wall 42. The front part facing the profile 12 of each wall support 40 is provided with at least one of the aforementioned wheels 20, preferably two paired, idly rotating wheels 20, intended to abut the sliding rail 19 of said profile. In practice, the door 14 once opened proves connected to the support 40 by the wheels 20 which are in part arranged in the aforementioned rail 19 and allow the sliding of said door; along the floor, instead, said door rests and slides in the known manner on one or more wheels or bearings, abutting in a guide integrated flush with the floor. The rectangular reinforcement 44 comprises opposite vertical sides 54, at the lower end of which respective bevelled appendages 56, 58 are made, destined to be abutted by the pivoting slider 38 of one or other of the damper stops 24; the bevelled appendages 56 and 58 project underneath from the wall support 40 and act as actuators of the pivoting sliders 38 which, during the sliding of the door 14 in opening or closing, compress the coil spring 28 or piston stem 26.

In order to adapt to the misalignment of the damper stops 24 fixed to the profile 12, hence to the resulting misalignment of the relative pivoting sliders 38, the bevelled appendages 56 and 58 made at the lower end of opposites vertical sides of the reinforcement 44 of the wall support 40 are also consistently misaligned, as can be seen in particular from FIGS. 3 and 4.

Given the misalignment of the damper stops 24 fixed to the base 22 of the profile section 12, the stem of the pistons 26 of both said damper stops can freely extend in a complete manner meeting no obstacles, while remaining in any case inside the maximum extension of said damper stops the same being true in relation to the coil spring 28. As a result, when the door 14 is pushed, even abruptly, open or closed, said totally exposed stem ensures the adequate and progressive braking of said door. Compared to previous known solutions, where the stroke of the stem of each piston 26 could be about 30 mm, according to the invention it can be much greater and reach up to 60 mm.

In detail, during the sliding open or closed of the door 14 one of the bevelled appendages 56 or 58 couples the pivoting slider which rotates in part, slides, guided in the groove 34 by the projecting pawl 50 which it is fitted with and abuts both the stem of the piston 26 and the coil spring 28; the previously fully extended spring is compressed and loaded contributing to the progressive braking of the door 14, while at the same time the entirely exposed stem of the piston 26 progressively moves rearwards achieving the complete and gradual braking of said door. If, during the opening phase of the door 14 the bevelled appendage 56 of the wall support 40 couples for example the pivoting slider 38 of the damper stop placed outermost on the profile 12, in the closing phase, i.e. when the sliding direction of the door 14 is inverted it is the bevelled appendage 58 of the wall support 40 which couples the pivoting slider 38 of the damper stop placed innermost on the profile 12. As a result, a single wall support 40, provided with two opposite and misaligned protruding appendages 56 and 58, can advantageously be used to activate the pivoting sliders of both damper stops 24, even if misaligned with respect to the profile 12 which they are fixed to.

As may be seen from the above, the advantages which the invention achieves are evident.

The sliding and braking device for sliding doors of the present invention allows a more effective damper braking of the doors 14 given the possibility of fully exploiting both the stroke of the piston stems 26 and the extension of the coil spring 28, in any case while respecting the overall size of the damper stops 24; this due to the fact that said damper stops are fixed misaligned with each other to the profile 12.

A further advantage is the ability to use wall supports 40 of a single type provided with opposite and misaligned bevelled appendages 56, 58, which actuate the pivoting sliders 38 of said damper stops 24.

Despite the invention having been described above with reference to one of its possible embodiments, given solely by way of a non-limiting example, numerous modifications and variants will appear evident to a person skilled in the art in the light of the above description, also bearing in mind the fact that the device according to the invention, appropriately sized, may also be used with the sliding doors of wardrobes. The present invention therefore sets out to embrace all the modifications and variants which fall within the sphere and scope of the following claims.

1) A device (10) for the sliding and braking of sliding doors and shutters, especially for closing and passing through two adjacent rooms, comprising a profile (12) made of metal or other suitable material having a substantially “C” shaped cross-section with lower horizontal branch or base (22), fixed with screws or equivalent means to the inner side of the door (14) to be moved and fitted with an inverted “U” constituting the guide (19) for one or more wheels (20) of at least one support (40) attached to the wall (42) above the through opening between said rooms, further comprising two damper stops (24) each composed of a piston (26), a coil spring (28) positioned above one another and a pivoting slider (38), characterised in that the two damper stops (24) are opposite and fixed along the base (22) of the profile (12) misaligned with each other, one of them being closer to the vertical branch (16) of said profile (12), the pivoting slider (38) which said damper stops are provided with abutting with an appendage (56) or (58) protruding from said at least one support (40) and defining an actuator.

2) The device according to claim 1, characterised in that the pivoting slider (38) of the damper stops (24) acts in conjunction with the appendage (56) or (58) to compress and move rearwards both the coil spring (28) and the stem of the piston (26) of said damper stops (24), said appendages being misaligned with each other consistently with the misalignment of the damper stops (24) and of the pivoting slider (38) which said stops are fitted with.

3) The device according to claim 1, characterised in that one of the damper stops (24) is fixed on the base (22) a little behind the vertical branch (16) of the profile (12), whereas the opposite damper stop (24) is fixed on the same base (22) along the outermost part away from said vertical branch (16).

4) The device according to claim 1, characterized in that the inverted “U” seat constituting the guide or sliding rail (19) of one or more wheels (20) of said at least one support (40) is made by the bending of the upper branch (18) of said profile (12), which extends horizontally cantilevered in the opposite direction to the door (14) and is bent downwards.

5) The device according to claim 4, characterized in that said at least one wall support (40) comprises a substantially rectangular perimetral reinforcement (44), which defines and bears integrally a shaped plate (46) intended to be fastened with wall plugs (48) to said wall (42), the front part facing the profile (12) of the wall bracket (40) being provided with two paired wheels (20) idly rotating, destined to abut with the sliding rail (19) of said section.

6) The device according to claim 2, characterised in that the substantially rectangular perimetral reinforcement (44) of the wall bracket (40) comprises opposite vertical sides (54), at the lower end of which said bevelled appendages (56), (58) are made intended to abut with the pivoting slider (38) of one or other damper stops (24).
